(19) United States
(12) Patent Application Publication
(10) Pub. No.: US 2026/0059623 A1
(43) Pub. Date: Feb. 26, 2026

(54) OPTOELECTRONIC MODULE AND METHOD FOR OPERATING AN OPTOELECTRONIC MODULE

(71) Applicant: ams-OSRAM International GmbH, Regensburg (DE)

(72) Inventor: Daniel DIETZE, Regensburg (DE)

(21) Appl. No.: 19/126,147

(22) PCT Filed: Oct. 17, 2023
(86) PCT No.: PCT/EP2023/078760

§ 371 Date: Apr. 30, 2025

(30) Foreign Application Priority Data
Nov. 4, 2022 (DE) 10 2022 129 162.6

(51) Int. Cl. H05B 45/14; H05B 45/18; H05B 45/325; H05B 45/395; H05B 45/56

(52) U.S. Cl. CPC H05B 45/14; H05B 45/18; H05B 45/325; H05B 45/395; H05B 45/56

(57) ABSTRACT

An optoelectronic module includes at least one light emitting diode that emits light with a luminous intensity during operation. The optoelectronic module also includes an integrated circuit which sets an operating current of the light emitting diode and measures a value of the forward voltage of the light emitting diode during operation. The integrated circuit determines a degradation of the light emitting diode by measuring the value of the forward voltage and increases or decreases the electrical operating current as a function of the measured value of the forward voltage, such that a change in the luminous intensity due to the degradation is at least partially compensated. The integrated circuit or a measurement-control-unit for controlling the integrated circuit includes a memory in which calibration data is stored. The calibration data comprises a value of the forward voltage of the light emitting diode as a reference value for determining the degradation.

An optoelectronic module and a method for operating an optoelectronic module are specified.

An optoelectronic module with an improved stability against age-related changes in a luminous intensity is to be specified. This object is solved by the subject-matter with the features of independent patent claim 1.

Furthermore, a method for operating an optoelectronic module with improved stability against age-related changes in luminous intensity is to be specified. This object is solved by a method with the features of independent patent claim 6.

Advantageous embodiments and further developments of the optoelectronic module and of the method for operating an optoelectronic module are specified in the dependent claims.

According to an embodiment, the optoelectronic module comprises at least one light emitting diode that emits light with a luminous intensity during operation. For example, the light emitting diode emits electromagnetic radiation during operation. In particular, the light emitting diode emits light in a spectral range between infrared light and ultraviolet light. Preferably, the light emitting diode emits light in a visible spectral range during operation. In particular, the light emitting diode converts an electrical operating current into light.

Here and in the following, luminous intensity refers to the luminous flux generated by the light emitting diode per solid angle and is specified in particular in the unit “candela”. The luminous flux corresponds to a radiant power of the light emitting diode, which is weighted with a wavelength-dependent sensitivity of the human eye. The radiant power refers to the energy per time that is transported by the emitted light.

In particular, the light emitting diode comprises an epitaxial semiconductor layer stack comprising an active layer for converting the electrical operating current into electromagnetic radiation. The active layer comprises, for example, a pn-junction, which can be formed as a quantum well structure or as a multiple quantum well structure.

According to a further embodiment, the optoelectronic module comprises an integrated circuit which sets an operating current of the light emitting diode and measures a value of the forward voltage of the light emitting diode during operation. The integrated circuit is, for example, an application-specific integrated circuit (short: ASIC).

In particular, the integrated circuit comprises an electrical circuit for setting the electrical operating current of the light emitting diode. For example, the electrical circuit comprises an adjustable electrical current source.

Furthermore, the integrated circuit comprises an electrical circuit for measuring the forward voltage of the light emitting diode. Here and in the following, the forward voltage refers in particular to an electrical voltage that drops across the semiconductor layer stack of the light emitting diode while a constant forward operating current is flowing through the light emitting diode. In other words, the forward voltage corresponds to an electrical voltage drop between an anode and a cathode of the forward biased light emitting diode.

According to a further embodiment of the optoelectronic module, the integrated circuit determines a degradation of the light emitting diode by measuring the value of the forward voltage. Here and in the following, degradation refers to an age-related change in the luminous intensity of the light emitting diode at a given electrical operating current.

For example, defects form in the active layer during operation of the light emitting diode. Furthermore, defects already present in the semiconductor layer stack can migrate into the active layer or out of the active layer during operation of the light emitting diode. These defects are, for example, defects or dislocations in a crystalline order of the semiconductor layer stack. An increase in a defect density in the active layer due to ageing of the light emitting diode can, for example, lead to a reduction in the internal quantum efficiency of the light emitting diode. Thus, in particular, as the light emitting diode ages, the luminous intensity of the light emitted by the light emitting diode decreases at a given electrical operating current. The defect density in the active layer can also decrease with increasing age of the light emitting diode, whereby the luminous intensity of the light emitting diode increases, for example.

The forward voltage of the light emitting diode at given operating parameters, in particular at a given operating current and at a given temperature, can change, for example, as a function of the defect density in the active layer. In particular, the degradation of the light emitting diode correlates with an ageing-related change in the forward voltage at given operating parameters. Thus, a change in the forward voltage of the light emitting diode at given operating parameters can be used as a measure of the degradation of the light emitting diode. For example, the forward voltage decreases when the luminous intensity decreases due to the degradation of the light emitting diode, or vice versa

According to a further embodiment of the optoelectronic module, the integrated circuit increases or decreases the electrical operating current of the light emitting diode as a function of the measured value of the forward voltage, such that a change in the luminous intensity due to degradation is at least partially compensated. For example, the integrated circuit increases or decreases an operating current that is constant over time. The integrated circuit can also increase or decrease a time-averaged value of the operating current, for example if the luminous intensity of the light emitting diode is adjusted by pulse-width modulation of the operating current.

In particular, the compensation is carried out such that the change in luminous intensity due to degradation is at least partially compensated for by the increase or decrease in the operating current and an associated change in luminous intensity. In other words, the operating current is increased when the luminous intensity of the light emitting diode decreases due to degradation, and/or vice versa.

For example, at the time of a calibration, the light emitting diode has a certain luminous intensity at a predetermined first operating current and a certain forward voltage at a predetermined second operating current. The first and second operating currents can be the same or different. After a certain operating time of the light emitting diode following calibration, the luminous intensity at the first operating current and the forward voltage at the second operating current change due to the degradation of the light emitting diode, for example. In particular, the integrated circuit now determines the value of the changed forward voltage at the second operating current as a measure of the degradation of the light emitting diode. Then, the first operating current is increased or decreased as a function of the measured value of the forward voltage, for example, in such a way that the luminous intensity of the degraded light emitting diode at the first operating current corresponds to the luminous intensity at the first operating current at the time of calibration, or deviates from it as little as possible.

According to a preferred embodiment, the optoelectronic module comprises:
at least the light emitting diode that emits light with a luminous intensity during operation,
the integrated circuit which sets the operating current of the light emitting diode during operation and measures the value of the forward voltage of the light emitting diode, wherein
the integrated circuit determines the degradation of the light emitting diode by measuring the value of the forward voltage and increases or decreases the electrical operating current as a function of the measured value of the forward voltage, such that the change in luminous intensity due to the degradation is at least partially compensated.

In particular, the optoelectronic module described herein is based on the idea of controlling a change in the luminous intensity of the light emitting diode due to age-related degradation purely electronically and compensating for it if necessary. The degradation is advantageously determined by measuring the forward voltage of the light emitting diode with an integrated circuit, which can also control the operating current of the light emitting diode.

In particular at relatively low operating currents, the forward voltage correlates with the defect density in the active layer of the light emitting diode and thus with the degradation of the light emitting diode, for example. The measured value of the forward voltage can thus be used to adjust the operating current of the light emitting diode in such a way that the age-related change in luminous intensity is at least partially compensated.

For example, with the optoelectronic module described herein, it is advantageously possible to dispense with an expensive burn-in of the light emitting diode as part of the manufacturing of the optoelectronic module. During burn-in, the light emitting diode is operated at a maximum operating current over a longer period of time, in particular before an optical calibration of the luminous intensity, in order to prevent rapid initial degradation during operation after the calibration. In contrast to burn-in, the optoelectronic module described herein advantageously allows for a monitoring of the degradation during operation.

Furthermore, the optoelectronic module described herein does not require a costly recording of an operating time and/or of a temperature evolution during operation in order to at least partially compensate for the age-related change in luminous intensity. In particular, the measured value of the forward voltage in the optoelectronic module described herein is advantageously directly related to the degradation of the light emitting diode. By contrast, the operating time or the temperature evolution, for example, is only an indirect gauge of the degradation of the light emitting diode. In particular, the operating time or the temperature evolution contain no information about the individual state of degradation of the light emitting diode in the optoelectronic module. By contrast, in the optoelectronic module described herein, the degradation can be compensated as a function of the individual state of the light emitting diode. Compensation can therefore be performed with greater accuracy.

Moreover, the optoelectronic module described herein does not require an optical light intensity sensor for monitoring the degradation of the light emitting diode. Thus, the optoelectronic module described herein can be advantageously manufactured at low cost.

According to a further embodiment of the optoelectronic module, the integrated circuit comprises an analog-digital converter that measures the value of the forward voltage during operation. In particular, the analog-digital converter measures and digitizes the forward voltage at predetermined points in time. For example, the analog-digital converter measures electrical voltages up to a maximum voltage between 1 volt and 3 volts, inclusive, with an accuracy between 0.1 millivolt and 10 millivolts, inclusive. Accordingly, the analog-digital converter comprises, for example, a resolution between 7 bits and 15 bits, inclusive.

According to a further embodiment of the optoelectronic module, the integrated circuit or a measurement-control-unit for controlling the integrated circuit comprises a memory in which the measured value of the forward voltage is stored. The measurement-control-unit is arranged, for example, outside the optoelectronic module and is configured for controlling the integrated circuit for measuring the value of the forward voltage of the light emitting diode. Furthermore, the integrated circuit or the measurement-control-unit can calculate the change in the operating current on the basis of the stored value of the forward voltage in order to at least partially compensate for the age-related change in the luminous intensity of the light emitting diode.

Furthermore, calibration data of the optoelectronic module can be stored in the memory. In particular, the calibration data comprises a relationship between the luminous intensity of the light emitting diode and the electrical operating current of the light emitting diode. Furthermore, the calibration data preferably comprises the value of the forward voltage of the light emitting diode as a reference value for determining the degradation. The calibration data can also include a relationship between the luminous intensity of the light emitting diode and the operating temperature of the light emitting diode. The calibration data is stored in the memory, for example, after a calibration of the optoelectronic module.

According to a further embodiment of the optoelectronic module, the integrated circuit comprises a pulse width modulator, wherein the pulse width modulator modulates the operating current of the light emitting diode to control the luminous intensity. In particular, the pulse width modulator changes the operating current periodically as a function of time. For example, the operating current can assume two different values within a period during two corresponding time intervals of different lengths. Preferably, one value of the operating current corresponds to a maximum operating current of the light emitting diode, while the other value corresponds to a vanishing operating current. In other words, at one value of the operating current, the light emitting diode emits light with maximum luminous intensity, while at the other value of the operating current, no light is emitted. The period is less than 20 milliseconds, for example, in order to avoid a perceptible, disturbing flickering of the optoelectronic module.

By setting a duty cycle between the two values of the operating current, the pulse width modulator can in particular provide any time average value of the operating current between 0 amperes and the maximum operating current. The duty cycle indicates a time ratio between the two time intervals during which the operating current assumes the two respective different values. The duty cycle is preferably specified as a percentage. For example, at a duty cycle of 0% the light emitting diode emits no light on average over time, while at a duty cycle of 100% light is emitted with maximum luminous intensity on average over time. By setting the time-average value of the operating current with the pulse width modulator, a color shift of the light emitted by the light emitting diode can be advantageously reduced or avoided compared to setting a corresponding constant operating current. Furthermore, the luminous intensity of the light emitted by the light emitting diode is directly proportional to the duty cycle.

According to a further embodiment, the optoelectronic module comprises three light emitting diodes which emit electromagnetic radiation in a red, green and blue spectral range during operation, respectively. In particular, a first light emitting diode emits red light, a second light emitting diode emits blue light and a third light emitting diode emits green light. For example, the optoelectronic module can emit light of any mixed color by adjusting the relative luminous intensities of the three light emitting diodes accordingly.

According to a further embodiment of the optoelectronic module, the integrated circuit controls electrical operating currents of the three light emitting diodes separately from each other and measures the values of the forward voltages of the three light emitting diodes independently of each other to determine the degradation. Thus, in particular, the degradation of each of the three light emitting diodes is determined independently of each other.

According to a further embodiment of the optoelectronic module, the integrated circuit at least partially compensates for the change in luminous intensity of each of the three light emitting diodes due to degradation. Thus, a color stability of the optoelectronic module can be advantageously increased if the three light emitting diodes degrade differently. By compensating for the ageing-related changes in the respective luminous intensities of the three light emitting diodes, the integrated circuit at least partially compensates, in particular, for an ageing-related change in the color coordinates of the mixed light emitted by the optoelectronic module.

Furthermore, a method for operating an optoelectronic module is specified. In particular, the method can be used to operate an optoelectronic module as described herein. All features of the optoelectronic module are also disclosed for the method for operating an optoelectronic module and vice versa.

According to an embodiment of the method for operating an optoelectronic module, a luminous intensity of at least one light emitting diode is first set by controlling an electrical operating current with an integrated circuit. Preferably, the operating current is pulse-width modulated. The luminous intensity is set, for example, by specifying the duty cycle or the time average of the pulse-width modulated operating current.

According to a further embodiment of the method, a degradation of the light emitting diode is determined by measuring a value of a forward voltage with the integrated circuit. Preferably, the forward voltage is measured at predetermined operating parameters of the light emitting diode, for example at a predetermined electrical operating current and/or at a predetermined temperature. For example, in addition to a dependence on the degradation, the forward voltage also has a dependence on the temperature of the light emitting diode. In particular, by measuring the forward voltage at the same operating parameters, the influence of degradation on the forward voltage can be separated from other effects. This improves the accuracy of the compensation of the change in luminous intensity due to ageing, for example.

According to a further embodiment of the method, when setting the luminous intensity, a change in the luminous intensity due to degradation is compensated for by increasing or decreasing the electrical operating current as a function of the measured value of the forward voltage. In particular, the operating current is changed by increasing or decreasing it. For example, the electrical operating current of the light emitting diode is changed as a function of the measured value of the forward voltage in such a way that the luminous intensity of the light emitted by the degraded light emitting diode at least approximately corresponds to the luminous intensity of the light emitting diode with the unchanged operating current at the time of calibration.

According to a preferred embodiment, the method for operating the optoelectronic module comprises the steps of:
setting the luminous intensity of at least one light emitting diode by controlling the electrical operating current with the integrated circuit,
determining the degradation of the light emitting diode by measuring the value of the forward voltage with the integrated circuit, wherein
when setting the luminous intensity, the change in luminous intensity due to degradation is compensated for by increasing or decreasing the electrical operating current as a function of the measured value of the forward voltage.

Preferably, the steps of the method are carried out in the above order. The above-mentioned steps of the method can be carried out as often as desired.

According to a further embodiment of the method, the degradation of the light emitting diode is determined when the light emitting diode is switched on and/or at predetermined times. For example, the value of the forward voltage is determined each time the optoelectronic module is switched on and/or after specified service intervals.

Furthermore, it is also possible to measure the value of the forward voltage, for example, continuously during operation of the optoelectronic module. For example, in the case of pulse width modulation, one of the two values of the operating current can be configured for measuring the forward voltage. In particular, this is possible if the specified value of the operating current for measuring the forward voltage is so small that the light emitting diode emits no light or no perceptible light. In this case, the forward voltage of the light emitting diode is measured during a partial period of the pulse width modulation in which the light emitting diode emits no perceptible light.

According to a further embodiment of the method, the forward voltage is measured at a predetermined value of the operating current. Preferably, the forward voltage is measured at several points in time, with the predetermined value of the operating current having the same value for each measurement of the forward voltage. This improves, for example, the accuracy of the compensation of the change in luminous intensity due to ageing. In particular, the predetermined operating current for measuring the forward voltage is selected such that the change in the forward voltage due to degradation is particularly sensitive to the degradation of the light emitting diode.

According to a further embodiment of the method, the predetermined value of the electrical operating current for measuring the forward voltage is selected such that a statistical correlation between a change in the forward voltage and a change in the luminous intensity due to the degradation of the light emitting diode after a predetermined operating time is largest. For example, the forward voltage and luminous intensity are measured both at the beginning and at the end of the predetermined operating time for a plurality of identical optoelectronic modules for a plurality of different operating currents. For example, the change in forward voltage is determined as the ratio of the measured values of forward voltage at the beginning and at the end of the predetermined operating time for a predetermined operating current. Similarly, the change in luminous intensity is determined, for example, as the ratio of the measured values of luminous intensity at the beginning and at the end of the predetermined operating time at the predetermined operating current. From the measured change in forward voltage and from the measured change in luminous intensity of each of the plurality of optoelectronic modules, a measure of their statistical correlation for different operating currents can be calculated. The predetermined operating time is, for example, between one hour and 48, inclusive.

In particular, to calculate the statistical correlation, the change in forward voltage and the change in luminous intensity are considered as two statistical random variables. For example, a Pearson's correlation coefficient between the measured changes in luminous intensity and the measured changes in forward voltage can be calculated as a measure of their statistical correlation. In particular, the Pearson's correlation coefficient corresponds to a covariance between the two random variables divided by standard deviations of the two random variables. Here, the covariance corresponds to an expectation value of the product of the difference between the first random variable and its mean value and the difference between the second random variable and its mean value.

The statistical correlation between the change in forward voltage and the change in luminous intensity is, in particular, a function of the electrical operating current of the light emitting diode. Preferably, the electrical operating current at which the statistical correlation between the change in forward voltage and the change in luminous intensity is largest is selected when measuring the value of the forward voltage to determine the degradation.

According to a further embodiment of the method, the predetermined electrical operating current for measuring the forward voltage is between 50 microamperes and 5 milliamperes, inclusive.

According to a further embodiment of the method, when setting the luminous intensity of the light emitting diode, the electrical operating current is corrected with a compensation factor that depends linearly on the measured value of the forward voltage. For example, to compensate for degradation, a value of an operating current that is constant over time is changed by the compensation factor. To compensate for the degradation, the duty cycle of the pulse width modulation of the operating current can also be changed by the compensation factor. For example, the duty cycle is increased or decreased in inverse proportion to the compensation factor. The duty cycle can also be increased or decreased in proportion to the compensation factor.

In particular, the compensation factor is a linear function of the measured value of the forward voltage. The compensation factor can also be an arbitrary function of the value of the forward voltage. For example, the compensation factor is a polynomial, i.e. a sum of multiples of powers of the measured value of the forward voltage.

According to a further embodiment of the method, the compensation factor depends on predetermined compensation parameters. The compensation parameters are, for example, coefficients in the polynomial formed by powers of the measured value of the forward voltage. In the case of a linear relationship between the measured value of the forward voltage and the compensation factor, the compensation factor comprises two compensation parameters, for example.

According to a further embodiment of the method, the compensation parameters are determined by measuring the change in luminous intensity due to degradation for a plurality of identical light emitting diodes and a subsequent statistical evaluation. For example, both the change in luminous intensity and the change in the value of the forward voltage after a predetermined operating time are measured for the plurality of identical light emitting diodes. A regression analysis is then used to determine a relationship between the change in luminous intensity and the change in forward voltage. In particular, a polynomial, for example a linear, relationship between the change in luminous intensity and the change in forward voltage is assumed and the coefficients of the polynomial, i.e. the compensation parameters, are determined by the regression analysis. For example, the compensation parameters are determined by minimizing a mean square deviation of the measured changes in luminous intensity and forward voltage from the assumed polynomial relationship.

According to a further embodiment of the method, a temperature of the light emitting diode is determined immediately before or after measuring the value of the forward voltage to determine the degradation. For example, the temperature of the light emitting diode is measured using a temperature sensor.

According to a further embodiment of the method, the temperature of the light emitting diode is determined by measuring the value of the forward voltage at a predetermined electrical operating current which is larger than the electrical operating current for determining the degradation. The forward voltage of the light emitting diode at a given electrical operating current depends in particular on the temperature of the active layer. Thus, in particular, the temperature of the light emitting diode can be determined from a measurement of the forward voltage at a given operating current. For example, the temperature of the light emitting diode is measured at a value of the operating current recommended for continuous operation of the light emitting diode. The larger the specified operating current, the larger the change in the forward voltage due to a change in temperature, for example. This can advantageously increase the accuracy of the temperature measurement.

According to a further embodiment of the method, the measured value of the forward voltage is corrected if the temperature deviates from a predetermined temperature when determining the degradation of the light emitting diode. In particular, the measured value of the forward voltage for determining the degradation is corrected in such a way that the corrected value at least approximately corresponds to the value of the forward voltage at the predetermined temperature. Thus, temperature differences in different measurements of the forward voltage for determining the degradation can be at least partially compensated. This advantageously improves the accuracy of the compensation of the degradation.

According to a further embodiment of the method, the measured value of the forward voltage is corrected using a known relationship between the forward voltage and the temperature of the light emitting diode at a predetermined operating current. For example, the forward voltage decreases or increases by a known amount when the temperature of the light emitting diode increases by one degree Celsius. By multiplying the temperature deviation, i.e. the difference between the measured temperature of the light emitting diode and the predetermined temperature, by the known amount of increase or decrease in the forward voltage per degree Celsius, the corrected value of the forward voltage can be determined, in particular.

According to a further embodiment of the method, the optoelectronic module is calibrated prior to a first operation. In particular, the optoelectronic module is optically calibrated before the first operation. The calibration can also be performed after a specific operation time of the optoelectronic module or at several points in time after different times of operation. During calibration, for example, the luminous intensity of the emitted light and/or color coordinates of the optoelectronic module are measured at predetermined operating parameters, for example operating current and temperature. In particular, the measured values are stored in the memory of the integrated circuit.

According to a further embodiment of the method, a relationship between the electrical operating current and the luminous intensity of the light emitting diode is determined during calibration. In particular, the luminous intensity of the emitted light is measured for a plurality of predetermined values of the operating current. Furthermore, a relationship between the temperature and the luminous intensity can be measured for a given operating current.

According to a further embodiment of the method, the value of the forward voltage of the light emitting diode is measured during calibration under the same conditions as when determining the degradation at later points in time. The measured value of the forward voltage is stored subsequently. In particular, the value of the forward voltage measured during calibration is stored in the memory of the integrated circuit or in the memory of the external measurement-control-unit.

In particular, the value of the forward voltage measured during calibration represents a reference value with respect to which the degradation of the light emitting diode is determined. For example, to determine the degradation of the light emitting diode, the value of the forward voltage is measured after a certain operating time and compared with the reference value. The change in the forward voltage is, for example, proportional to the degradation of the light emitting diode.

Further advantageous embodiments and further developments of the optoelectronic module and of the method for operating an optoelectronic module become apparent from the exemplary embodiments described below in connection with the figures.

FIG. 1 shows a schematic view of an optoelectronic module according to an exemplary embodiment.

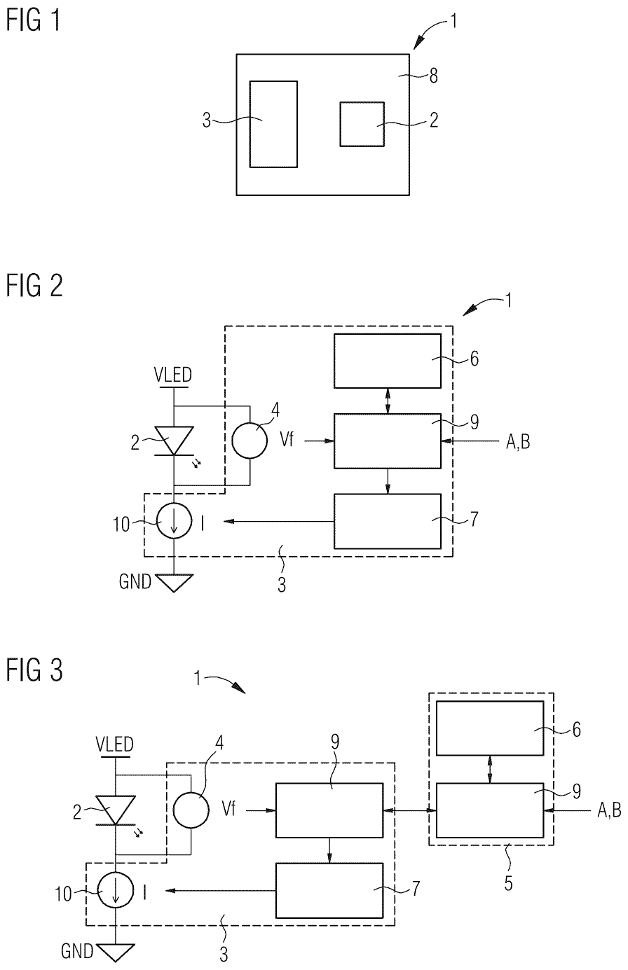

FIGS. 2 and 3 show schematic block diagrams of optoelectronic modules according to different exemplary embodiments.

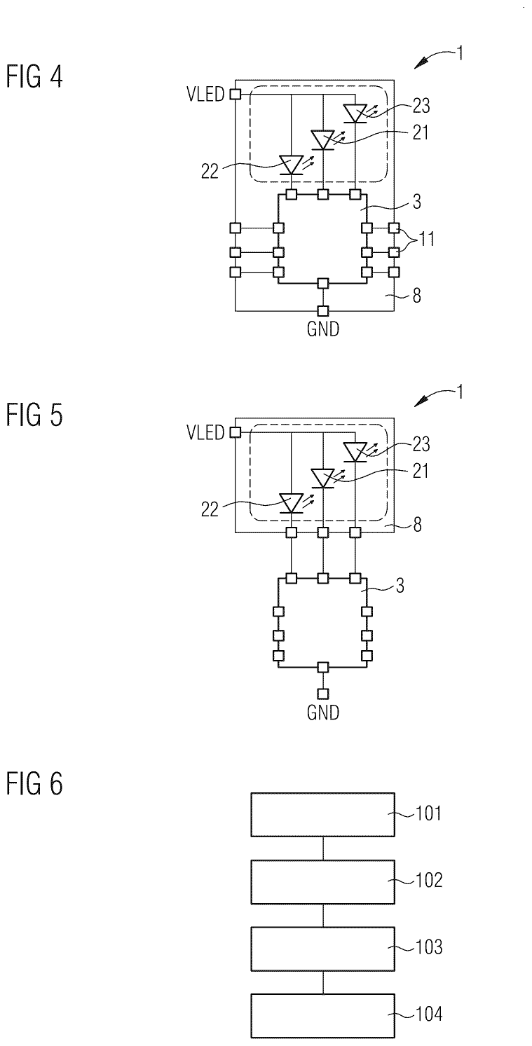

FIGS. 4 and 5 show schematic circuit diagrams of optoelectronic modules according to further exemplary embodiments.

FIG. 6 shows a schematic flowchart of a method for operating an optoelectronic module according to an exemplary embodiment.

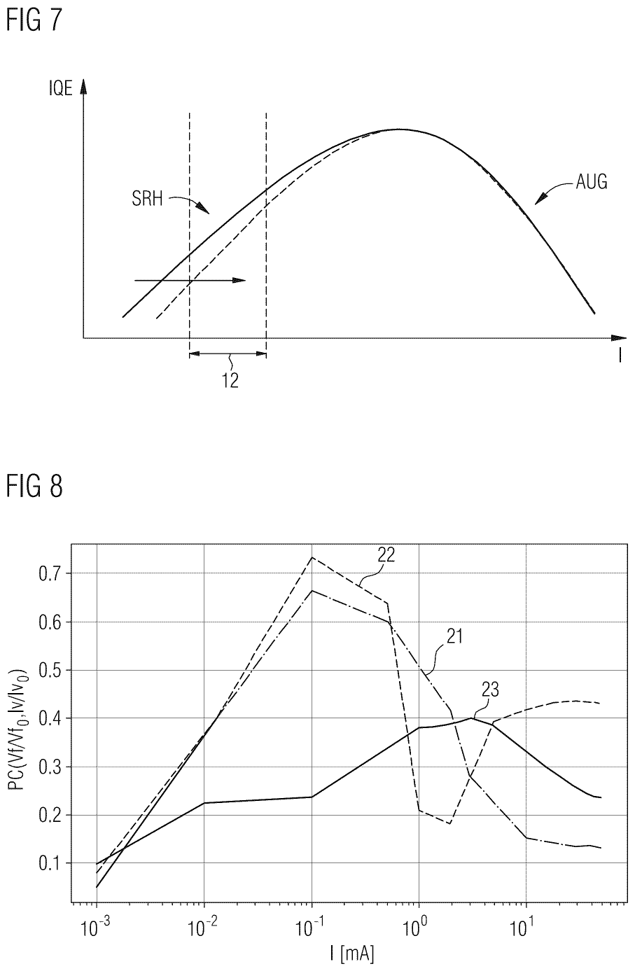

FIG. 7 shows an example of a schematic diagram of an internal quantum efficiency of a light emitting diode as a function of an operating current.

FIG. 8 shows an example of a diagram of a statistical correlation between a degradation-related change in forward voltage and a degradation-related change in luminous intensity as a function of an operating current of a light emitting diode.

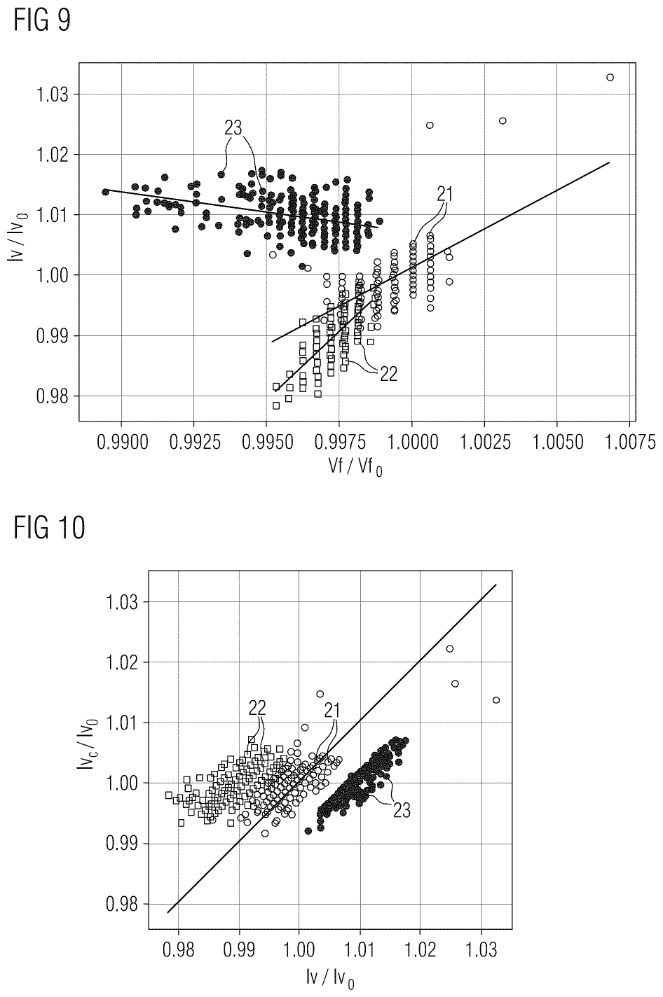

FIG. 9 shows an example of a diagram of a degradation-induced change in luminous intensity as a function of a degradation-induced change in the forward voltage of a light emitting diode.

FIG. 10 shows an example of a diagram of a compensated degradation as a function of an uncompensated degradation for a plurality of optoelectronic modules.

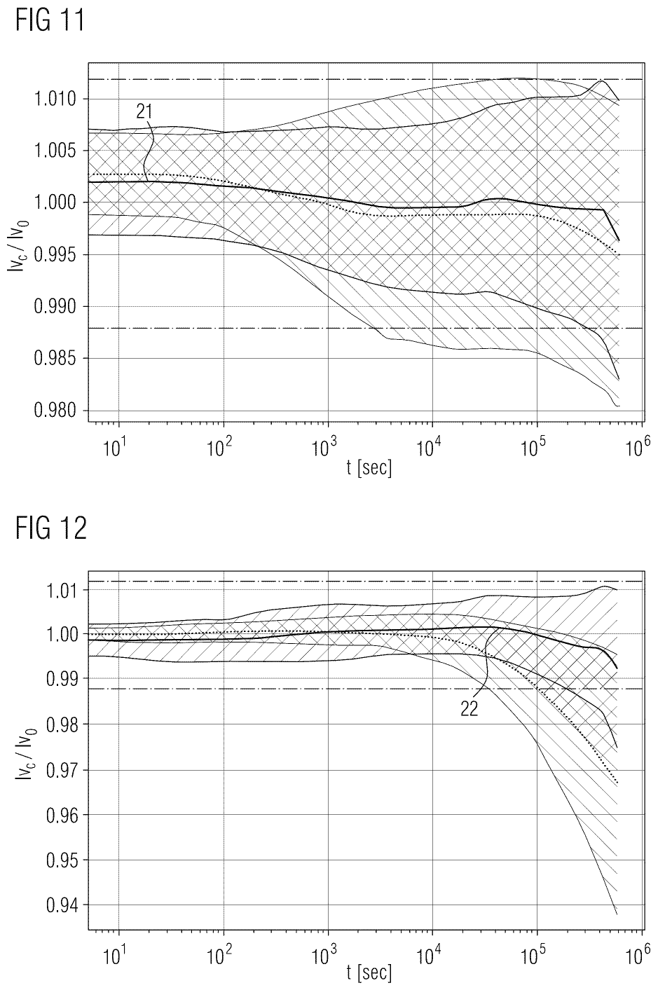

FIGS. 11, 12 and 13 show compensated degradations of optoelectronic modules according to various exemplary embodiments as a function of the operating time of the optoelectronic module.

Elements that are identical, similar or have the same effect are marked with the same reference signs in the figures. The figures and the proportions of the elements shown in the figures should not be considered to be true to scale. Rather, individual elements may be shown in exaggerated size for better visualization and/or understanding.

The optoelectronic module 1 according to the exemplary embodiment in FIG. 1 comprises a light emitting diode 2 and an integrated circuit 3, which are arranged on a main surface of a common carrier 8. The carrier 8 comprises electrical contact surfaces via which the light emitting diode 2 and the integrated circuit 3 are electrically contacted. Furthermore, the carrier 8 comprises electrical terminal contacts for external electrical contacting of the optoelectronic module 1 on a surface opposite the main surface. The carrier 8 comprises, for example, a plastic, a ceramic and/or a metal, or consists of one of these materials. In particular, the optoelectronic module 1 can be surface-mountable.

The light emitting diode 2 comprises a semiconductor layer stack with an active layer for converting an electrical operating current I into electromagnetic radiation. In particular, the light emitting diode 2 emits light in the visible spectral range during operation. A luminous intensity Iv of the light emitted by the light emitting diode 2 can be adjusted via the electrical operating current I.

The integrated circuit 3 comprises an electrical circuit for setting the electrical operating current I of the light emitting diode 2, as well as an electrical circuit for measuring a forward voltage Vf of the light emitting diode 2. The integrated circuit 3 is configured for determining an age-related degradation of the light emitting diode 2 by means of a measurement of a value of the forward voltage Vf. In particular, for measuring the forward voltage Vf, a predetermined constant operating current I is applied to the light emitting diode 2, at which the forward voltage Vf is particularly sensitive to the degradation of the light emitting diode 2. In other words, at the predetermined operating current I, there is a high statistical correlation between a degradation-related change in luminous intensity Iv and a degradation-related change in the forward voltage Vf of the light emitting diode 2.

Furthermore, the integrated circuit 3 is configured for at least partially compensating for the degradation-related change in the luminous intensity Iv of the light emitted by the light emitting diode 2 on the basis of the measured value of the forward voltage Vf. For this purpose, the integrated circuit 3 increases or decreases the operating current I of the light emitting diode 2 as a function of the measured value of the forward voltage Vf. In particular, the operating current I is changed such that the luminous intensity Iv of the light emitted by the light emitting diode 2 at least approximately corresponds to the luminous intensity Iv at the time of an optical calibration of the light emitting diode 2 at the unchanged operating current I.

FIG. 2 shows a schematic block diagram of an optoelectronic module 1 according to the exemplary embodiment described in connection with FIG. 1. The anode of the light emitting diode 2 is connected to an electrical supply voltage VLED, while the cathode of the light emitting diode 2 is connected to a reference potential GND via a current source 10 in the integrated circuit 3. In particular, the current source 10 is configured for providing the electrical operating current I of the light emitting diode 2.

The integrated circuit 3 further comprises an electrical circuit, in particular an analog-digital converter 4, for measuring the forward voltage Vf of the light emitting diode 2, as well as a pulse width modulator 7, a control unit 9 and a memory 6. The analog-digital converter 4 for measuring the forward voltage Vf is electrically connected to the anode and the cathode of the light emitting diode 2 and transmits the measured value of the forward voltage Vf to the control unit 9, which stores the value in the memory 6.

The control unit 9 controls the pulse width modulator 7, which pulse width modulates the operating current I of the light emitting diode 2. In particular, the control unit 9 specifies a duty cycle of the pulse-width modulated operating current I for adjusting the luminous intensity Iv of the light emitting diode 2.

Furthermore, the control unit 9 calculates a compensation factor F from the measured value of the forward voltage Vf and from predetermined compensation parameters A, B. In particular, the duty cycle of the pulse-width modulated operating current I is changed inversely proportional to the compensation factor F in order to at least partially compensate for the degradation-related change in the luminous intensity Iv of the light emitting diode 2. The compensation parameters A, B are stored in the memory 6, for example during manufacturing of the optoelectronic module 1.

FIG. 3 shows a schematic block diagram of an optoelectronic module 1 according to a further exemplary embodiment. In contrast to the exemplary embodiment described in connection with FIG. 2, the optoelectronic module 1 additionally comprises an external measurement-control-unit 5. For example, the external measurement-control-unit 5 is not arranged on the common carrier 8, but is spatially separated from the integrated circuit 3 and from the light emitting diode 2. Furthermore, the external measurement-control-unit 5 can, for example, control several integrated circuits 3 with associated light emitting diodes 2. In particular, the memory 6 is part of the measurement-control-unit 5 instead of the integrated circuit 3. The measurement-control-unit comprises a control unit 9 which receives the measured value of the forward voltage Vf from the control unit 9 of the integrated circuit 3 and stores it in the memory 6. In particular, in this exemplary embodiment, the control unit 9 of the measurement control unit 5 calculates the compensation factor F from the compensation parameters A, B and the measured value of the forward voltage Vf and sends it to the control unit 9 of the integrated circuit to change the duty cycle of the pulse width modulator 7. Furthermore, the measurement control unit 5 controls the times at which the value of the forward voltage Vf is measured by the integrated circuit 3.

The optoelectronic module 1 according to the exemplary embodiment in FIG. 4 comprises an integrated circuit 3 and three light emitting diodes 21, 22, 23, which are arranged on a common carrier 8. The anodes of the three light emitting diodes 21, 22, 23 are connected to a common electrical supply voltage VLED, while the cathodes of the three light emitting diodes 21, 22, 23 are electrically connected to corresponding terminals of the integrated circuit 3. During operation, the first light emitting diode 21 emits light in the red spectral range, while the second light emitting diode 22 emits light in the green spectral range and the third light emitting diode 23 emits light in the blue spectral range.

The integrated circuit 3 controls the operating currents I of the three light emitting diodes 21, 22, 23 independently of one another, so that relative luminous intensities Iv of the light emitted by the three light emitting diodes 21, 22, 23 can be adjusted. In particular, the optoelectronic module 1 can emit mixed light of any color during operation.

Furthermore, the integrated circuit 3 determines the degradation of each of the three light emitting diodes 21, 22, 23 independently of each other by measuring the respective forward voltage Vf. Using the measured forward voltages Vf, the integrated circuit compensates for age-related changes in the luminous intensities Iv of the three light emitting diodes 21, 22, 23. In particular, this advantageously at least partially compensates for an age-related color shift of the optoelectronic module 1.

The optoelectronic module 1 comprises terminal contacts 11 for connecting the integrated circuit 3 to a serial bus. Via the serial bus, the integrated circuit 3 exchanges data with the external measurement-control-unit 5, for example (not shown here, see FIG. 3, for example).

In contrast to the exemplary embodiment in FIG. 4, the optoelectronic module 1 according to the exemplary embodiment in FIG. 5 comprises an integrated circuit 3 which is not arranged together with the three light emitting diodes 21, 22, 23 on the carrier 8, but is spatially separated from them. For example, this allows the light emitting diodes 21, 22, 23 of several optoelectronic modules 1 to be arranged next to each other in a particularly compact manner, while the associated integrated circuits 3 are arranged away from the light emitting diodes 21, 22, 23.

FIG. 6 shows different steps 101, 102, 103, 104 of a method for operating the optoelectronic module 1 according to the exemplary embodiment in FIG. 2. In a first step 101, the optoelectronic module 1 is calibrated. In particular, the luminous intensity Iv of the light emitted by the light emitting diode 2 is measured as a function of the electrical operating current I at a constant temperature and stored as a reference value of the luminous intensity Iv₀. Furthermore, the forward voltage Vf of the light emitting diode is measured and stored at a predetermined electrical operating current I and at a constant temperature. The predetermined operating current I is selected such that the change in the forward voltage Vf is particularly sensitive to the degradation of the light emitting diode 2. The selection of the predetermined operating current I is described, for example, in connection with FIG. 8. The measured value of the forward voltage Vf is stored as the reference value Vf₀ in the memory 6 of the integrated circuit 3.

In a second step 102, the optoelectronic module 1 is in operation and the light emitting diode 2 emits light with an adjustable luminous intensity Iv. Here, the luminous intensity Iv is set by pulse width modulation of the operating current I with the integrated circuit 3. In particular, the luminous intensity Iv is proportional to the duty cycle of the pulse-width modulated operating current I.

In a third step 103, after a predetermined operating time of the optoelectronic module 1, for example after a service interval, the value of the forward voltage Vf of the light emitting diode 2 is measured under the same operating conditions as during calibration. In particular, Vf is measured at the same predetermined operating current I and at the same temperature of the optoelectronic module 1 as during calibration. By measuring this value of the forward voltage Vf, the degradation of the light emitting diode 2 is determined. For example, the degradation-related change in the luminous intensity Iv/Iv₀ of the light emitted by the light emitting diode 2 is at least approximately proportional to the change in the value of the forward voltage Vf/Vf₀, the changes being determined relative to the reference values Iv₀, Vf₀ from the calibration.

In a fourth step 104, the change in luminous intensity Iv due to the degradation of the light emitting diode 2 during the further operation of the optoelectronic module 1 is at least partially compensated for by the integrated circuit 3. For this purpose, the integrated circuit 3 calculates a compensation factor F, which depends on the value of the forward voltage Vf measured in step 103, on the reference value measured in step 101 and on compensation parameters A, B. In particular, the compensation factor F has the form

$$F = A \frac{Vf}{{Vf}_{0}} + B , \qquad ( G 1 )$$

where A and B are the compensation parameters, Vf denotes the measured value of the forward voltage from step 103 and Vf₀ denotes the reference value of the forward voltage from step 101. In particular, the compensation factor F describes a change in the luminous intensity Iv of the light emitted by the degraded light emitting diode 2 relative to the luminous intensity Iv at the time of calibration of the optoelectronic module 1. The compensation parameters A, B are determined, for example, as described in connection with FIG. 9. In particular, the compensation parameters A, B are stored in the memory 6 of the integrated circuit 3 during manufacturing of the optoelectronic module 1.

The duty cycle PWM of the pulse width modulated operating current I is corrected with the compensation factor F during further operation of the optoelectronic module 1:

$${PWM}_{c} = \frac{PWM}{A \frac{Vf}{{Vf}_{0}} + B} . \qquad ( G 2 )$$

Here PWM_{c} denotes the corrected duty cycle and PWM denotes the original duty cycle. The pulse width modulation of the operating current I of the light emitting diode 2 with the corrected duty cycle PWM_{c} at least partially compensates for the degradation-related change in the luminous intensity Iv of the light emitting diode 2. In particular, the luminous intensity Iv of the light generated with the corrected duty cycle PWM_{c} corresponds at least approximately to the luminous intensity Iv of the light generated with the duty cycle PWM at the time of calibration. Since the time-averaged luminous intensity Iv of the light emitted by the light emitting diode 2 is directly proportional to the duty cycle PWM of the pulse width modulated operating current I, the degradation can be advantageously at least partially compensated for in a simple manner by the correction of the duty cycle PWM_{c} described above.

Steps 101 to 104 are preferably carried out in this order. Steps 103 and 104 can be repeated several times during operation of the optoelectronic module 1. As a result, the degradation of the light emitting diode 2 during operation of the optoelectronic module 1 can be advantageously determined more precisely and subsequently compensated for with greater accuracy.

FIG. 7 shows an example of a schematic internal quantum efficiency IQE of a light emitting diode 2 as a function of the operating current I. The internal quantum efficiency IQE corresponds to the number of photons emitted by the active layer of the light emitting diode 2 per number of charge carriers injected into the active layer. The internal quantum efficiency IQE is limited, for example, by non-radiative recombination processes of charge carriers in the active layer. For example, non-radiative Shockley-Read-Hall (SRH) recombination dominates for small operating currents I, while non-radiative Auger (AUG) recombination dominates for large operating currents. In Shockley-Read-Hall recombination, for example, the charge carriers recombine at a defect in the crystal lattice of the active layer.

Due to the degradation the internal quantum efficiency IQE of the light emitting diode 2 is changed, for example. The internal quantum efficiency IQE is reduced particularly strongly at low operating currents I (see arrow and dashed line in FIG. 7), where Shockley-Read-Hall recombination dominates. Advantageously, the forward voltage Vf of the light emitting diode 2 is particularly sensitive to the defect density in the active layer and thus to the degradation of the light emitting diode 2 at these small operating currents I. The operating current I for measuring the forward voltage Vf is advantageously not selected too small so that the measured value of the forward voltage Vf is not influenced or as little as possible influenced by noise. Furthermore, the operating current I for measuring the forward voltage Vf is advantageously not too large so that the degradation has the greatest possible effect on the measured value of the forward voltage Vf. A preferred region 12 of operating currents I, at which the degradation of the light emitting diode 2 can be determined from the measured value of the forward voltage Vf, is marked in FIG. 7.

FIG. 8 shows the Pearson's correlation coefficient PC between the relative change in the forward voltage Vf/Vf₀ and the relative change in the luminous intensity Iv/Iv₀. The Pearson's correlation coefficient PC is calculated from the measured changes in the forward voltage Vf/Vf₀ and the luminous intensity Iv/Iv₀ for a plurality of identical light emitting diodes 2 after an operating time of 24 hours as a function of the operating current I. The Pearson's correlation coefficient PC is calculated, for example, from measured values of the change in the forward voltage Vf/Vf₀ and the change in the luminous intensity Iv/Iv₀ of at least one hundred identical light emitting diodes 2. In particular, Pearson's correlation coefficients PC are shown in FIG. 8 for three different types of light emitting diodes 21, 22, 23. The first light emitting diode 21 emits red light, while the second light emitting diode 22 emits green light and the third light emitting diode 23 emits blue light.

For the first light emitting diode 21 and the second light emitting diode 22, the Pearson's correlation coefficient PC is largest at an operating current I of approximately 100 microamperes, while the Pearson's correlation coefficient PC is largest at an operating current I of approximately 3 milliamperes for the third light emitting diode 23. Advantageously, the predetermined operating current I for determining the degradation of the light emitting diodes 21, 22, 23 is selected on the basis of the measurement of the value of the forward voltage Vf such that the Pearson's correlation coefficient PC is largest at this predetermined operating current I. As a result, the degradation-related change in the luminous intensity Iv of the light-emitting diodes 21, 22, 23 can be compensated for with high accuracy by measuring the forward voltage Vf.

FIG. 9 shows measured values of a relative change in the luminous intensity Iv/Iv₀ as a function of the relative change in the value of the forward voltage Vf/Vf₀ at a given operating current I after an operating time of the light emitting diode 2 of 24 hours. In particular, measured values are shown for a plurality of first, second and third light emitting diodes 21, 22, 23 which are part of an optoelectronic module 1 in which there is no compensation for degradation. The predetermined operating current I for measuring the value of the forward voltage Vf is selected as described in connection with FIG. 8.

In particular, FIG. 9 shows linear relationships between the relative change in forward voltage Vf/Vf₀ and the relative change in luminous intensity Iv/Iv₀ obtained by linear regression of the corresponding measured values for each of the first, second and third light emitting diodes 21, 22, 23. The linear relationship is given by the equation

$$\frac{Iv}{{Iv}_{0}} = A \frac{Vf}{{Vf}_{0}} + B , \qquad ( G 3 )$$

where A and B are the compensation parameters and the right-hand side of equation (G3) corresponds to the compensation factor from equation (G1) described in connection with FIG. 6. In particular, the linear regression is used to determine the compensation parameters A and B used in the method for operating the optoelectronic module to compensate for degradation.

In particular, the linear relationships shown in FIG. 9 are shifted away from the point (Iv/Iv₀, Vf/Vf₀)=(1, 1). In other words, there may be a change in the measured luminous intensity Iv on a statistical average, although the forward voltage Vf of the light emitting diode 2 has not changed. This deviation can be caused, for example, by an age-related change in an absorption coefficient of the carrier 8 or other parts of the optoelectronic module 1, which influences the measured luminous intensity Iv.

FIG. 10 shows measured values of the relative change of the luminous intensity Iv_{c}/Iv₀ of a plurality of optoelectronic modules 1 according to an exemplary embodiment, wherein the degradation was compensated according to the method described herein, as a function of the relative change of the luminous intensity Iv/Iv₀ without compensation of the degradation. In particular, the measured values along the vertical axis are centered around Iv_{c}/Iv₀=1. This shows that the degradation can be at least partially compensated for by the method described here.

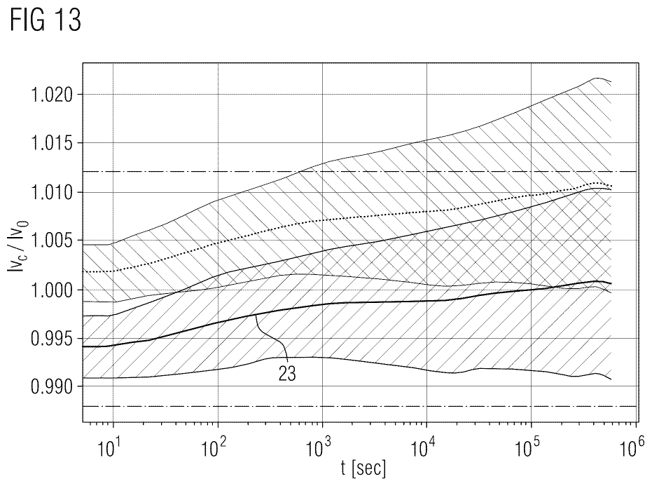

FIGS. 11, 12 and 13 show a relative change in the luminous intensity Iv_{c}/Iv₀ of the light emitting diode 2 in an optoelectronic module 1 according to an exemplary embodiment, wherein the degradation is at least partially compensated, as a function of the operating time. Here, FIG. 11 shows the change in luminous intensity Iv for a first light emitting diode 21, FIG. 12 for a second light emitting diode 22 and FIG. 13 for a third light emitting diode 23 according to the exemplary embodiment in FIG. 4. The compensation is carried out as described in connection with the exemplary embodiment in FIG. 6. For comparison, the dotted line shows the relative change in the luminous intensity Iv/Iv₀ without compensation for the degradation of the light emitting diode 2. In particular, FIGS. 11, 12 and 13 show mean values of the relative change in the luminous intensity Iv_{c}/Iv₀, where the luminous intensity Iv was averaged over 280 identical light emitting diodes 2. Furthermore, a threefold standard deviation (±3σ) of the relative change in luminous intensity Iv for a plurality of identical light emitting diodes 2 is shown. In particular, FIGS. 11, 12 and 13 show that the compensation of degradation according to the method described here is particularly effective for long operating times.

This patent application claims the priority of the German patent application DE 102022129162.6, the disclosure content of which is hereby incorporated by reference.

The invention is not limited to the exemplary embodiments by the description thereof. Rather, the invention includes any new feature as well as any combination of features, which includes in particular any combination of features in the patent claims, even if this feature or combination itself is not explicitly stated in the patent claims or exemplary embodiments.

### REFERENCES

1 optoelectronic module
2 light emitting diode
21 first light emitting diode
22 second light emitting diode
23 third light emitting diode
3 integrated circuit
4 analog-digital converter
5 measurement-control-unit
6 memory
7 pulse width modulator
8 carrier
9 control unit
10 current source
11 terminal contact
12 region
101 first step
102 second step
103 third step
104 fourth step
A, B compensation parameters
AUG Auger recombination
I operating current
IQE internal quantum efficiency
Iv luminous intensity
Iv₀ reference value of the luminous intensity
Iv_{c} compensated luminous intensity
PC Pearson's correlation coefficient
SRH Shockley-Read-Hall recombination
t time
Vf forward voltage
Vf₀ reference value of the forward voltage
VLED supply voltage
GND reference potential

1. An optoelectronic module, comprising:
at least one light emitting diode that emits light with a luminous intensity during operation,
an integrated circuit which sets an operating current of the light emitting diode and measures a value of the forward voltage of the light emitting diode during operation, wherein
the integrated circuit determines a degradation of the light emitting diode by measuring the value of the forward voltage and increases or decreases the electrical operating current as a function of the measured value of the forward voltage, such that a change in the luminous intensity due to the degradation is at least partially compensated, and
the integrated circuit or a measurement-control-unit for controlling the integrated circuit comprises a memory in which calibration data is stored, wherein the calibration data comprises a value of the forward voltage of the light emitting diode as a reference value for determining the degradation.

2. The optoelectronic module according to claim 1,
wherein the integrated circuit comprises an analog-digital converter that measures the value of the forward voltage during operation.

3. The optoelectronic module according to claim 1, wherein
the measured value of the forward voltage is stored in the memory.

4. The optoelectronic module according to claim 1, wherein
the integrated circuit comprises a pulse width modulator, and
the pulse width modulator modulates the operating current of the light emitting diode to control the luminous intensity.

5. The optoelectronic module according to claim 1, wherein
the optoelectronic module comprises three light emitting diodes which emit light in a red, green and blue spectral range during operation, respectively,
the integrated circuit controls electrical operating currents of the three light emitting diodes separately from one another and measures the values of the forward voltages of the three light emitting diodes independently of one another in order to determine the degradation, and
the integrated circuit at least partially compensates for the change in luminous intensity of each of the three light emitting diodes due to the degradation.

6. A method for operating an optoelectronic module comprising the steps of:
setting a luminous intensity of at least one light emitting diode by controlling an electrical operating current with an integrated circuit,
determining a degradation of the light emitting diode by measuring a value of a forward voltage with the integrated circuit, wherein
when setting the luminous intensity a change in the luminous intensity due to degradation is compensated for by increasing or decreasing the electrical operating current as a function of the measured value of the forward voltage, and
the optoelectronic module is calibrated prior to a first operation, and the calibration comprises a step of measuring and storing a value of the forward voltage of the light emitting diode under the same conditions as for determining the degradation at later times.

7. The method according to claim 6, the degradation of the light emitting diode is determined when the light emitting diode is switched on and/or at predetermined times.

8. The method according to claim 6, wherein
the forward voltage is measured at a predetermined value of the operating current.

9. The method according to claim 8, wherein the predetermined value of the electrical operating current for measuring the forward voltage is selected such that a statistical correlation between a change in the forward voltage and a change in the luminous intensity due to the degradation of the light emitting diode after a predetermined operating time is largest.

10. The method according to claim 6, wherein
the predetermined electrical operating current for measuring the forward voltage is between 50 microamperes and 5 milliamperes, inclusive.

11. The method according to claim 6, wherein
when setting the luminous intensity of the light emitting diode, the electrical operating current is corrected with a compensation factor that depends linearly on the measured value of the forward voltage.

12. The method according to claim 11, wherein
the compensation factor depends on predetermined compensation parameters, and
the compensation parameters are determined by measuring the change in luminous intensity due to degradation for a plurality of identical light emitting diodes and a subsequent statistical evaluation.

13. The method according to claim 6, wherein
a temperature of the light emitting diode is determined immediately before or after measuring the value of the forward voltage to determine the degradation.

14. The method according to claim 13, wherein
the temperature of the light emitting diode is determined by measuring the value of the forward voltage at a predetermined electrical operating current which is larger than the electrical operating current for determining the degradation.

15. The method according to claim 13, wherein
the measured value of the forward voltage is corrected if the temperature deviates from a predetermined temperature when determining the degradation of the light emitting diode, and
the measured value of the forward voltage is corrected using a known relationship between the forward voltage and the temperature of the light emitting diode at a predetermined operating current.

16. The method according to claim 6, wherein
the calibration comprises a further step in which a relationship between the electrical operating current and the luminous intensity of the light emitting diode is determined.
